(19) United States
(12) Patent Application Publication
(10) Pub. No.: US 2025/0348964 A1
(43) Pub. Date: Nov. 13, 2025

(54) Vertical AI-Assisted Closing Argument and Supporting Exhibit Cues System and Method

(71) Applicant: Anthony Jeremiah Bayne, Lomita, CA (US)

(72) Inventor: Anthony Jeremiah Bayne, Lomita, CA (US)

(21) Appl. No.: 19/275,925

(22) Filed: Jul. 21, 2025

Related U.S. Application Data
(60) Provisional application No. 63/824,839, filed on Jun. 16, 2025.

(51) Int. Cl. G06Q 50/18; G06F 16/334; G06F 21/62

(52) U.S. Cl. CPC G06Q 50/18; G06F 16/334; G06F 21/6254

(57) ABSTRACT

A system and method for assisting in the preparation of a closing argument in a legal proceeding. The system receives case-related notes and transforms them into a machine-readable format. Structured key facts are extracted and used to query a database of historical certified shorthand reporter (CSR) transcripts containing verbatim closing arguments. The system employs one or more vertical artificial intelligence (AI) agents trained on large language models and domain-specific corpora, including court reporter transcripts of jury trials and other proceedings. These agents perform legal-specific fact extraction, case alignment, and argument generation. Matching arguments are automatically adapted and tailored to the pending case, with options for rhetorical structure selection and editable output. The invention facilitates monetization for court reporters, enhances attorney performance, and repurposes otherwise underutilized legal content.

### FEDERALLY SPONSORED RESEARCH OR DEVELOPMENT

Not applicable.

### FIELD OF THE INVENTION

The present invention relates to an educational tool for attorneys, and more specifically a system and method to provide a searchable trial database to aid an attorney in preparing for a closing argument.

### BACKGROUND

Court Reporters, Stenographers, Certified Shorthand Reporters, Electronic Court Reporters, Digital Court Reporters, Voice Writers, Verbatim Reporter Transcriptionists, and Legal Transcriptionists (collectively “CSR” hereinafter) create word for word recordings of various civil and criminal hearings, including closing arguments, closing statements, closing speeches, oral conclusions, oral submissions, and the like (hereinafter collectively “closing argument(s)”).

The parties may purchase a copy of the transcript (or receive a free copy when the party is an indigent criminal defendant) from the CSR. There are some private companies that may sell some trial transcripts (e.g. of a high-profile or commercial litigation case). The transcript is archived for a time and may be destroyed.

While the transcripts of various hearings are sometimes requested by counsel, a transcript of the trial's closing argument is usually not made unless the case is appealed (e.g. in a criminal case where the defendant was found guilty). Likewise, there are legal services that report cases that may sometimes include portions of a court's ruling regarding an issue arising from the closing argument (e.g., an allegation of misconduct), but generally no substantial part of the closing argument is included in a reported case since closing arguments are not evidence.

Also, the reporters who prepare the transcripts are paid full price once for producing the transcripts and then a discounted fee for subsequent transcripts (e.g., California transcript fee schedule under Government Code § 69950). Once appeals are exhausted, if any, the transcripts often go unused.

A problem is that compelling arguments made by attorneys who have decades of experience in handling serious criminal cases (e.g., a murder), or civil actions involving millions of dollars in damages may be spoken once and never used again to be forgotten or destroyed. They become a legal sunken treasure of sorts.

In the practice of litigation, attorneys face significant challenges when preparing for closing arguments in both criminal and civil trials. Closing arguments must not only accurately reflect the trial's evidentiary record and applicable legal standards, but also persuade jurors using strategic rhetoric and storytelling. Traditionally, preparation for closing arguments is labor-intensive, relying heavily on manual review of transcripts, exhibits, evidence, and attorney notes-often under extreme time pressure. Attorneys must identify inconsistencies in testimony, determine how evidence supports or refutes specific legal elements, and find effective ways to communicate complex facts and legal theories to jurors who often have no legal training or desire to serve on a jury.

Moreover, existing tools fail to adequately assist attorneys in drawing lessons from similar prior cases. While databases of some court decisions exist, there is no statewide, or national jury trial transcript database. Case databases do not usually include closing arguments, offer practical tools for adapting previously made closing arguments to a pending case, or are known/accessible by attorneys who did not participate in creating the transcript (e.g., not an attorney of record).

Accordingly, there is a need for a computer-implemented system and method that transforms data of a pending case (e.g., one in which an attorney is engaged in trial) and uses information from similar prior proceedings to generate a proposed closing argument that improves attorney efficiency and effectiveness by leveraging the legal experience of other attorneys. There also remains a need for a new source of residual income for a CSR beyond producing an original and copies of their trial transcripts.

### BRIEF SUMMARY OF THE INVENTION

The problem of losing the use of previously made closing arguments of attorneys and to provide a new source of revenue for reporters, is solved by a system and method that uses CSR transcripts of prior hearings that contain the same or similar key facts in a pending case to generate a suggested closing argument. Also, while the invention will be described as an attorney using the invention, the term is meant to include a vertical Artificial Intelligence (AI) agent(s), or any other person/thing, or combination of them, that may use the system or method to help an attorney prepare for a closing argument.

In a preferred embodiment the invention comprises a system designed to generate a proposed closing argument for a pending legal proceeding by leveraging a series of integrated modules. It begins with a data ingestion module that receives case-related notes, which are then processed by a transformation engine to extract structured key facts in a machine-readable format. These key facts are used by a legal transcript query module to search a database of machine-readable certified shorthand reporter (CSR) transcripts containing historical verbatim closing arguments. A comparison engine identifies transcripts involving similar legal or factual circumstances, and a closing argument extraction module selects relevant portions of these transcripts, aligning them with evidence or themes pertinent to the current case. A closing argument generation module adapts this content into a draft argument tailored for the pending proceeding. The system may also include a jurisdictional code retrieval module for applicable statutes and jury instructions, a pseudonymization engine to mask personally identifiable information, and a style adaptation module that modifies the tone or rhetorical emphasis based on user input or context. Vertical artificial intelligence agents, trained or fine-tuned using legal data including CSR transcripts, may implement one or more of these modules. Additionally, the system can generate visual or textual cues prompting the attorney to reference admitted exhibits during the argument, with slide transitions synchronized to support delivery. An interface module may allow users to purchase full or partial CSR transcripts for additional context, supporting transcript monetization. The AI agent may also assess exhibit relevance to optimize the argument's structure and integration with visual aids.

As used herein, the term “case-related notes” refers to observations recorded by legal professionals, including but not limited to an attorney, paralegal, law clerk, or client, that pertain to events occurring during courtroom proceedings and are not reflected in the certified shorthand reporter (CSR) transcript. Such observations may include, without limitation, a witness's nonverbal behavior, physical reactions to specific lines of questioning, or latency in verbal responses while testifying—each of which may be perceptible to the attorney, presiding judge, or members of the jury.

The term “key facts,” as used herein, encompasses data points or observations that bear relevance to the legal and factual analysis of a case. This includes, but is not limited to, information indicating evidentiary inconsistencies, factual support for or against one or more elements of a legal claim or defense, or circumstantial facts that give rise to a reasonable inference relating to such elements. Additionally, key facts may include any observation or datum that a legal professional designates as materially relevant to the proceeding.

Querying the historical transcript database includes using natural language processing (NLP) or keyword extraction techniques. In certain embodiments, a user of the system or method may limit a query to a look back period of a specified time, or time range. For example, if there was a change in the law applicable to the user's case that occurred five years ago and could impact the outcome, the user could limit the query to a look back of five years when the law was amended, reinterpreted, overruled, etc. Additionally, a query may be made of transcripts where the lead attorney (e.g. for the petitioner) had a certain number of years of experience at the time the attorney made an argument. This may be accomplished by comparing the attorney's name in a historic transcript to a state bar (other) database and looking up when the attorney was admitted to practice law in the relevant jurisdiction, and then calculating the difference between the date of the attorney's admission to the date the historic argument was made to determine years of experience. In this way the user of the system or method can better estimate the experience of the attorney making the argument that may be used to generate a suggested argument. Further, the system or method may include the option for a user to select from arguments that ultimately prevailed in whatever verdict the user wants in the user's case. In this option a “verdict” may include a “hung jury”, or a declaration of a “mistrial” by a judge.

Once a proposed argument is generated the system and method may then offer the person using the system or method the opportunity to purchase the entire CSR transcript, or a section/pages of it, for a greater understanding of the context in which an argument was made, so that the CSR may earn new revenue from a transcript that would likely never have been used again.

Proceeds of any transcript purchased, or a portion of it, may be donated to a victim restitution board to help victims of crime rebuild their lives. Further, this opens a new market for CSR's to sell transcriptions of closing argument proceedings, since they are infrequently reproduced.

The system and method may further include automatically identifying and suggesting relevant memes, or quotes from well-known individuals such as political leaders, historical figures, entertainers, athletes, or scientists, to enhance the rhetorical impact of the attorney's closing argument. For example, the method may suggest a headline or quote from a news story that the jury may have seen in the local news that might suggest an independent proof of the attorney's position or emotionally sway them to the attorney's position.

Additionally, the system and method may suggest an argument formatted around a classical rhetorical argument structure (Aristotelian-Introduction/ethos, Narration/context, Confirmation/presents evidence, Refutation/Addresses counterarguments, Conclusion/Summarizes key points, Emotional appeal/Calls to action (e.g., vote “not guilty”), or other argument structures (Rogerian, Toulmin Model, Problem-Solution, etc.) that are known to be persuasive.

In certain embodiments, the system may be configured to generate a recommendation that the attorney user emphasize weaknesses in the opposing party's evidentiary support. Such weaknesses may include, for example, the absence of evidence for a required element, the presence of circumstantial evidence that supports multiple reasonable interpretations (i.e., at least one of those interpretations favorable to the attorney's position), or the existence of substantial evidence that affirmatively contradicts an essential element of the opposing party's claim or charge.

The method may also search for and suggest quotes/rulings from the judge presiding over the trial, or made by opposing counsel, that either support the attorney-user's position or undermine the opponent's current argument. For example, sometimes a judge may say something during voir dire that an attorney can repeat to a jury during closing argument to “borrow power” from the judge in making a point.

In another embodiment the invention includes a computer-implemented method for assisting in the preparation of a closing argument in a legal proceeding. The method comprises receiving, into a computer-readable database, case-related notes associated with a pending legal matter. These notes may include, but are not limited to, a charging document, a trial transcript, professional notes prepared by legal counsel, a visual or multimedia depiction of an exhibit, or an observation made in the courtroom that is not part of the official record, such as a witness's demeanor, physical reaction to a question, or latency in response while testifying. The received notes are transformed into a machine-readable format and processed to extract structured data comprising key facts relevant to the proceeding. The method further comprises retrieving, based on jurisdictional information, statutory elements corresponding to the alleged offense or cause of action, and querying a database of certified court reporter (CSR) transcripts that have been previously transformed into machine-readable format. These transcripts comprise verbatim attorney arguments recorded during prior trials and are annotated with metadata describing legal, procedural, and factual attributes. The key facts extracted from the pending matter are then compared against the metadata and structured transcript content in order to identify one or more relevant historical transcripts. A portion of at least one historical closing argument, associated with a successful or contextually relevant trial outcome, is selected. The method further comprises automatically generating a proposed closing argument by incorporating the selected portion of the historical closing argument, adapted to align with the key facts, exhibits, witness testimony, and jurisdiction-specific statutory elements relevant to the current proceeding. The generation of the proposed argument may further incorporate applicable rules drawn from jurisdiction-specific jury instructions. In some embodiments, the extracted key facts may include indicators of evidentiary inconsistencies, factual support or opposition to specific legal elements, or observations made by legal professionals. The historical arguments may be filtered according to crime type, cause of action, jurisdiction, or factual similarity to ensure contextual relevance. Additionally, the generated closing argument may include persuasive phrases or rhetorical techniques derived from prior arguments deemed effective. The method may optionally include enabling a user, such as an attorney, to select a preferred rhetorical style or argument format to guide the customization of the proposed closing argument. One or more sub-processes described herein may be performed using vertical artificial intelligence agents trained on large language models, particularly those adapted to legal discourse and trial transcript analysis.

The portion of the selected historical closing argument includes not only the words or phrases used by the attorney, but may also include an overall theme (e.g., the police arrested the wrong person), the way the attorney structured the argument (e.g., starting closing argument with the strongest argument in favor of the attorney's position), or strategy (e.g., conceding a lesser included offense to steer a jury away from returning a guilty verdict on a more serious offense).

In another embodiment, the invention comprises a non-transitory computer-readable medium that stores instructions which, when executed by one or more processors, cause a computing device to perform a method for assisting an attorney in preparing for the delivery of a closing argument in a legal proceeding. The method comprises receiving data comprising case-related notes associated with a pending legal matter. These notes are converted into a machine-readable format, after which the machine-readable content is parsed to extract structured data, wherein the structured data includes key facts relevant to the pending matter. The extracted key facts are then used as search parameters to query a database of court reporter transcripts, the transcripts having previously been converted into machine-readable format. Upon retrieval, the transcripts are parsed to extract structured data that also includes key facts from prior legal proceedings. The structured key facts from the case-related notes are compared with the structured data extracted from the certified court reporter transcripts to identify one or more transcripts that contain the same or similar key facts relevant to the pending case. From the set of identified transcripts, one or more closing arguments previously delivered by attorneys during trial are selected. Each selected closing argument may be associated with a party or witness in the pending matter to enhance contextual alignment. Based on these selected closing arguments, a new proposed closing argument is generated that is adapted to the key facts of the pending legal proceeding for use by an attorney during the closing phase of the trial. In certain embodiments, the generated closing argument incorporates text that has been adapted by a vertical artificial intelligence agent from a previously recorded attorney-delivered argument.

In this way an attorney can utilize the years of experience of other attorneys who argued similar cases to prepare a better closing argument.

The invention creates a new source of potential income for a CSR when their transcript is selected for purchase or use (i.e., a closing argument was selected for use).

### BRIEF DESCRIPTION OF THE DRAWINGS

FIG. 1 shows a system environment of the closing argument tool.

FIG. 2 shows a flow chart of the method for creating a closing argument.

### DETAILED DESCRIPTION OF THE INVENTION

Exemplary embodiments of the present invention will hereinafter be described with references to the figures, in which like numerals indicate elements throughout the several drawings. The following detailed description sets forth a preferred embodiment of the invention, which provides a computer-implemented method and system for generating an educational and analytical tool to assist an attorney in preparing a closing argument in connection with a legal proceeding.

As used herein the term “legal proceeding” should be construed broadly to comprises at least one of a jury trial, an adjudication, an arbitration, a mediation, an administrative hearing, a court martial, a motion to suppress evidence, a Daubert hearing, a bench trial, a hearsay exception determination, a character evidence/prior bad acts hearing, a confession admissibility hearing, a chain of custody/authentication hearing, a Rule 403 hearing/prejudicial vs. probative analysis a motion in limine, a mitigation hearing, a new trial motion, a resentencing hearing, and an ineffective assistance of counsel hearing.

In a preferred embodiment, the system ingests a collection of structured or unstructured case-related data, herein referred to as “case-related notes” and “trial materials”. Case-related notes corresponding to a pending trial in which the attorney is actively engaged. These case-related notes may include, but are not limited to: attorney notes, paralegal notes, intern notes, descriptions of exhibits, and informal courtroom observations made by attorneys or staff, such as witness demeanor, emotional responses, or long pauses in answering. Trial materials may include, but are not limited to: charging documents (e.g., an indictment or information), daily trial transcripts, copies of marked exhibits (e.g., that will likely be admitted into evidence, or have been admitted into evidence), pictures of exhibits, prior sworn testimony, video recordings, audio recordings, and stipulations.

Upon receipt, the case-related notes and/or trial materials are input into a computer-readable database. The system includes a privacy-compliance module configured to automatically pseudonymize sensitive information (e.g., in such a way to conform to the way the information was used during the evidentiary portion of the legal proceeding), such as health data subject to HIPAA or other applicable privacy laws. The pseudonymization process may involve redaction, replacement with anonymized identifiers, or hashing of protected information to ensure legal compliance.

For example, in a criminal prosecution for rape, a medical document that discloses a named victim's vagina was found to have an accused's DNA in it may normally be protected by HIPAA/other privacy laws, but for purposes of proving the case, the law in the jurisdiction may allow a narrow exception so that a prosecutor can move (publish) the victim's private medical records into evidence for a jury to consider when the government is prosecuting the case. In such situations, the last name of the victim/complaining witness may be represented by the first letter of her last name.

The inputted case-related notes are then transformed into a machine-readable format. The transformation step includes parsing the case-related notes using natural language processing (NLP) techniques and extracting structured data elements. Structured data may comprise key facts such as factual assertions, inconsistencies in testimony, observations supporting or refuting legal elements, and context-specific annotations. These facts are stored in a structured, queryable format.

Based on the jurisdiction of the pending case, the system retrieves the applicable statutory elements of the charged criminal offense or civil cause of action, along with the corresponding jury instructions. This retrieval is performed by a rules engine or a code repository that maps legal codes and instructions by jurisdiction and subject matter.

Using the extracted key facts, the system generates one or more search queries to access a historical database of certified shorthand reporter (CSR) transcripts. These transcripts are previously digitized and transformed into machine-readable formats and tagged with metadata that includes (but is not limited to) attributes such as jurisdiction, parties, attorneys, trial year, offenses, causes of action, special allegations, motions heard, legal rulings, timestamps, trial duration, law firm, prosecuting or defending agency, and outcome, jury split (e.g., 8-4 for not guilty). This metadata classification allows for efficient filtering and semantic comparison.

The system then compares the key facts from the pending case with those found in the historical CSR transcripts. The comparison process may involve keyword matching, semantic similarity scoring, contextual relevance, or other machine learning techniques. One or more relevant historical transcripts are identified based on factual and legal similarity.

From the identified transcripts, the system extracts corresponding closing arguments delivered by attorneys. These arguments are used—together with the retrieved statutory elements and/or jury instructions—to automatically generate a proposed closing argument tailored to the facts and legal posture of the pending case. The proposed argument may include persuasive rhetorical elements (e.g., analogies or memorable phrases) that enhance its effectiveness and may be further customized to match the tone or strategic approach preferred by the attorney.

Unlike prior art systems that generate arguments de novo, the present system enables attorneys to directly reuse verbatim rhetorical content from real closing arguments delivered by experienced lawyers in prior cases. This feature is neither disclosed nor suggested in any known system—even those with NLP or argument-generation capabilities—and provides unexpected benefits in persuasive efficacy, educational utility, and monetization of previously unused speech transcripts.

In preferred embodiments, one or more vertical artificial intelligence (AI) agents are employed to perform legal-context-aware parsing, semantic comparison, and rhetorical synthesis tasks. These vertical AI agents are specialized subsystems trained on legal corpora including but not limited to: statutory codes, jury instructions, attorney trial notes, evidentiary records, and, notably, certified court reporter (CSR) transcripts of prior jury trials and related proceedings. The vertical AI agents are implemented using or fine-tuned from large language models (LLMs), which have been augmented with legal reasoning capabilities and rhetorical style adaptation functionality.

Each vertical AI agent is tailored to a sub-task such as: (1) identifying relevant legal standards; (2) detecting admissible courtroom observations and associating them with evidence or legal themes; (3) retrieving and adapting historically successful closing arguments from the CSR transcript database; or (4) generating rhetorically persuasive output using a selectable structure (e.g., Aristotelian, Toulmin, Problem-Solution, etc.). The agents collaborate within a shared orchestration environment, where structured data is passed between them to produce a refined, legally compliant, and persuasive proposed closing argument.

The AI agents optionally include a learning feedback mechanism wherein attorneys may rate the effectiveness or usability of the proposed closing argument, which the system records and uses to retrain or reweight model parameters, improving future output relevance. These vertical AI agents thereby emulate the reasoning and persuasion tasks traditionally performed by experienced attorneys, while offering scalable efficiency and consistency across cases.

Additionally, the system allows for selection of rhetorical style at generation time. For example, an attorney may indicate a preference for a compassionate, aggressive, or professorial tone, or select from classical argumentation models. The vertical AI agents then adapt the reused historical content to conform to the desired tone and structure. This further distinguishes the invention from traditional legal databases and general-purpose AI tools.

The outputted closing argument may be presented in a format editable by the attorney, allowing for further revision or refinement. In some embodiments, the system may also rank or score historical transcripts or proposed arguments based on criteria such as relevance, outcome effectiveness, or jurisdictional precedence.

In further embodiments, the system may retrieve, based on jurisdictional information, applicable statutory elements or jury instructions corresponding to the alleged criminal offense or civil cause of action. These statutory elements may include jurisdiction-specific jury instructions. To identify relevant prior arguments, the method may involve querying a historical transcript database using natural language processing (NLP) or keyword extraction techniques. The historical transcripts may be classified using metadata, which may include one or more of the following: cause of action, alleged crime, use of expert witnesses, verdict outcome, law firm, party, attorney, judge, prosecuting or defending agency, or trial date range. The method may further comprise ranking the identified or selected historical transcripts based on factors such as relevance, similarity score, or effectiveness of the prior outcome. A proposed closing argument is then generated and presented in an editable format for attorney review and modification. The generated argument may incorporate text that has been adapted by a vertical artificial intelligence agent from a previously recorded attorney-delivered argument.

Additionally, the method may include generating prompts/cues for referencing exhibits admitted or anticipated to be admitted into evidence, and embedding these prompts within the proposed closing argument. Such prompts may include timing instructions aligned with audiovisual slide presentations that correspond to evidentiary content. Sensitive data within the case-related notes may be automatically pseudonymized in accordance with the data's treatment during the evidentiary portion of the trial, including masking protected health information and the identities of vulnerable individuals. One or more sub-tasks of the method may be performed using vertical artificial intelligence agents trained on large language models. These agents may be updated or retrained based on user feedback concerning the effectiveness or usability of the proposed arguments. In some embodiments, the system may further provide the attorney with the option to purchase either a full or partial certified court reporter (CSR) transcript to obtain additional context relevant to the generated closing argument.

In certain embodiments, the invention produces a technical effect by improving computational efficiency, information retrieval accuracy, and cognitive workload reduction for legal practitioners. The system achieves this by applying semantic metadata classification and AI-based similarity scoring to large sets of certified court reporter transcripts. This enables structured retrieval of legally relevant content based on key facts and legal issues, which in turn facilitates faster and more reliable generation of persuasive closing arguments. By leveraging trained vertical AI agents and pseudonymization modules, the system ensures privacy compliance while reducing the manual effort involved in trial preparation. This technical effect distinguishes the invention from systems that merely store or retrieve legal content without semantic processing or adaptive learning capabilities.

The system's technical advantages stem from the semantic alignment of structured factual context with persuasive rhetorical content—an operation requiring specialized legal-language NLP, metadata extraction, and contextual adaptation modules that cooperate to combine verbatim speech reuse with real-time case specifics—well beyond generic text generation.

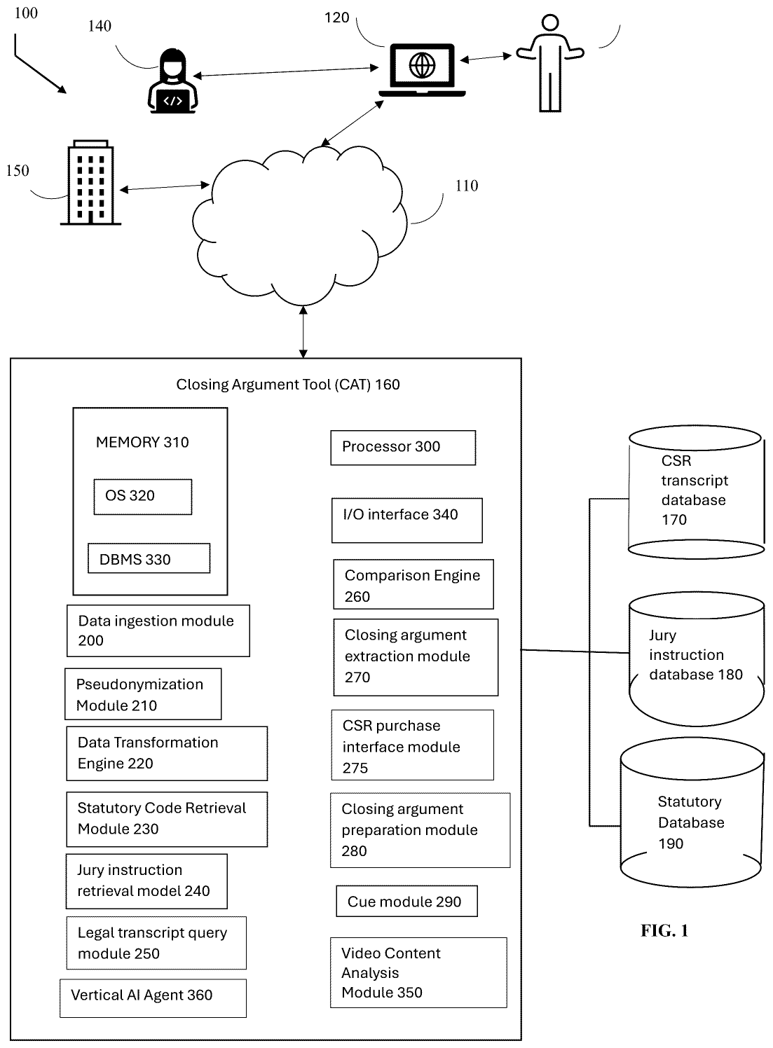

FIG. 1 shows a block diagram illustrating an exemplary operating environment for implementation of certain embodiments of the present invention. The system 100 may operate on a secure cloud-based infrastructure 110 using a Software-as-a-Service (SaaS) or Platform-as-a-Service (PaaS) model. The system 100 is accessible over a network 120 (e.g., the Internet) by an authorized user 130, such as a criminal defense attorney, prosecutor, or civil litigator, and a CSR 140.

A corporation (public or private) such as a legal technology company (e.g., LexisNexis, Thomas Reuters, etc.), a non-profit organization (e.g., National Court Reporters Association (NCRA)), a government agency (e.g., Los Angeles County, CA), or a combination of them (collectively “business” 150), may maintain the physical infrastructure, lease cloud services (e.g., from Amazon Web Services), use colocation services, or adopt a hybrid cloud/on-premise model.

Within this environment, the business 150 deploys a Closing Argument Tool (CAT) 160 and a database of CSR transcripts 170 of verbatim legal proceedings, that include closing arguments of attorneys 130 that the business 150 regularly updates (e.g., monthly). For example, a participating CSR 140 may upload their finished work product (e.g, certified transcripts/audio recording of a trial)) to the cloud 110, where the business 150 then reviews and uploads the proofed transcript into the CSR transcript database 170. Additionally, the business 150 may maintain a jury instruction database 180 for one or more jurisdictions (e.g, county, state, or country), and/or a statutory (e.g., laws, regulations, rules, etc.) database 190 for various legal specialties (e.g., civil, administrative, maritime, family law, etc.) for one or more jurisdictions accessible by the CAT 160.

The exemplary operating system 100 environment of the CAT 160 includes a data ingestion module 200 configured to receive case-related notes related to a pending legal case, a pseudonymization engine 210 configured to input the case-related notes into a computer-readable database and automatically pseudonymize any data subject to privacy laws consistent with the use of the data during the evidentiary portion of the legal proceeding, a data transformation engine 220 configured to automatically convert the case-related notes into a machine-readable format, and to parse and extract structured data from the case-related notes, a jurisdictional (j/x) statutory code retrieval module 230 configured to retrieve statutory elements (e.g., from the statutory database 190) corresponding to the alleged criminal offense or civil cause of action (in a pending legal proceeding that the attorney 130 is working on) from a jurisdiction-specific legal code.

In addition to, or instead of the jurisdictional (j/x) code retrieval module 230, the CAT 160 may further include a jurisdictional jury instruction retrieval module 240 configured to retrieve jury instructions (e.g. from a jury instruction database 180) corresponding to the jurisdiction in which the case is pending. Jury instructions often include lesser included offenses, and other legal insights (e.g., judicial commentary) that are not expressly stated in a statutory code.

The CAT 160 also includes a legal transcript query module 250 configured to use the case-related notes' key facts as search terms to query a database of court reporter (CSR) transcripts 170 that have been transformed into a machine-readable format, and to parse and extract structured data from said transcripts, a comparison engine 260 configured to automatically compare the structured data of the case-related notes with the structured data of the CSR transcripts, and to identify one or more relevant CSR transcripts that include a same or similar key fact(s) as found in the pending legal proceeding/case; a closing argument extraction module 270 configured to select, from the relevant CSR transcripts, one or more attorney closing arguments (i.e., arguments that support the user's position), and to associate the selected argument(s) with a party, a witness, and/or evidence (e.g., sworn testimony taken from a witness, a stipulation between parties, a judicially noticed fact, etc.) in the pending case; and a closing argument preparation module 280 configured to automatically generate a closing argument based on the selected closing arguments from the CSR transcripts and associated with a party or witness in the pending case. Additionally, the CAT 160 may include a cue (prompt) module 290 configured to generate a visual or textual cue indicating where in the generated argument an attorney 130 should reference an exhibit admitted into evidence during delivery of the closing argument.

The proposed argument may incorporate inferences made from the evidence presented at trial, or gaps in evidence, that are not otherwise made inadmissible by a court ruling (e.g., in California, USA, a California Evidence Code 402 hearing, or motion in limine ruling). For instance, even where some evidence suggests that another individual may have been present at the scene of the crime, a trial judge may rule—outside the presence of the jury—that the defense is precluded from arguing that the other individual likely committed the charged offense instead of his client. Such a ruling is typically based on a determination that the evidence is insufficient to support the inference and that advancing the argument would risk encouraging the jury to engage in impermissible speculation.

Additionally, the CAT 160 includes a processor 300 and memory 310. The processor 300 is configured to restrict access to registered users. For example, a defense attorney 130 visiting the business's 150 website may be required to enter login credentials or register a new account to access case data. The memory 310 that may take the form of any computer readable medium. The memory 310 stores data and program modules, for example, an operating system (“OS”) 320 and a database management system (“DBMS”) 330. The CAT 160 has a processor 300, and a memory 310 for storing data coupled to a processor 300. The processor 300 is configured to limit use of the CAT 160 to registered users. The CAT 160 may also include input/output (“I/O”) interfaces 340 for providing logical connections to various I/O devices, such as a scanner, a mouse, etc. A system administrator may utilize these and other I/O devices to interact with the CAT 160. For example, a system administrator may interact with the CAT 160 to populate and edit a registered user database (not shown), and other program modules. Those skilled in the art will appreciate that the CAT 160 may include alternate and/or additional components, hardware or software.

The system may include an interface module 275 configured to provide an option to an attorney 130 to purchase the full CSR transcript (or pages of it) for additional context and to facilitate monetization of transcripts for court reporters 140. For example, a court reporter 140 may license their work product (transcript) to an agency for a nominal amount, or pay an agency to make their work product available, so that the CSR 140 is paid a fixed amount for use of their transcript when an argument (or a part thereof) is taken from it, as well as having the CSR 140 paid for a copy of their entire transcript (or individual pages) when a user (e.g., an attorney 130, paralegal, etc.) wants greater context to the argument made.

The CAT 160 is a processor-driven system (or collection of devices) designed to register, verify, and authenticate users and generate a proposed closing argument. The CAT 160 may access computer-readable media containing data or instructions needed to perform methods of the invention. The processor 300 executes business logic, supporting server-side rules and computations such as selecting a desired argument style, and applicable jury instructions or criminal code sections from various relevant jurisdictions.

The system memory 310 may comprise any form of computer-readable media and can be logically or physically segmented. For example, the computer-readable media may comprise a non-transitory computer-readable medium storing instructions and a large language model (LLM) configured to process natural language inputs and generate context-aware outputs. The memory 310 stores programs and data, including the operating system (OS) 320 and a database management system (DBMS) 330. These and other modules enable the CAT 160 to perform the automated functions of the invention.

The CAT 160 may include or connect to multiple searchable databases, such as a jury instruction database 170, a jury instruction database 180, and a statutory code database 190. These databases may be logically or physically separate and store all relevant data used or generated by the CAT 160.

Input/output (I/O) interfaces 340 allow the CAT 160 to connect to devices such as scanners or mice. System administrators may use these interfaces to manage system functions, including populating and updating the CSR transcript database 170 and associated modules. The CAT 160 may include additional or alternative hardware and software components. For example, the CAT 160 may include an AI-powered Video Content Analysis (VCA) module 350 that allows an AI vertical agent to analyze video footage (e.g., an exhibit of police body worn video) to automatically identify extract, and describe key events, objects, or actions. Using computer vision, speech recognition, and natural language processing, the VCA 350 can detect people, interpret movement, transcribe dialogue, and generate concise textual summaries (e.g., with time stamps), of what occurred in the video. The VCA module 350 feature enables the CAT 160 to quickly identify relevant evidence or anomalies for inclusion in a closing argument.

To use the CAT 160, a person or organization may register via the business's 150's website using any internet-enabled device.

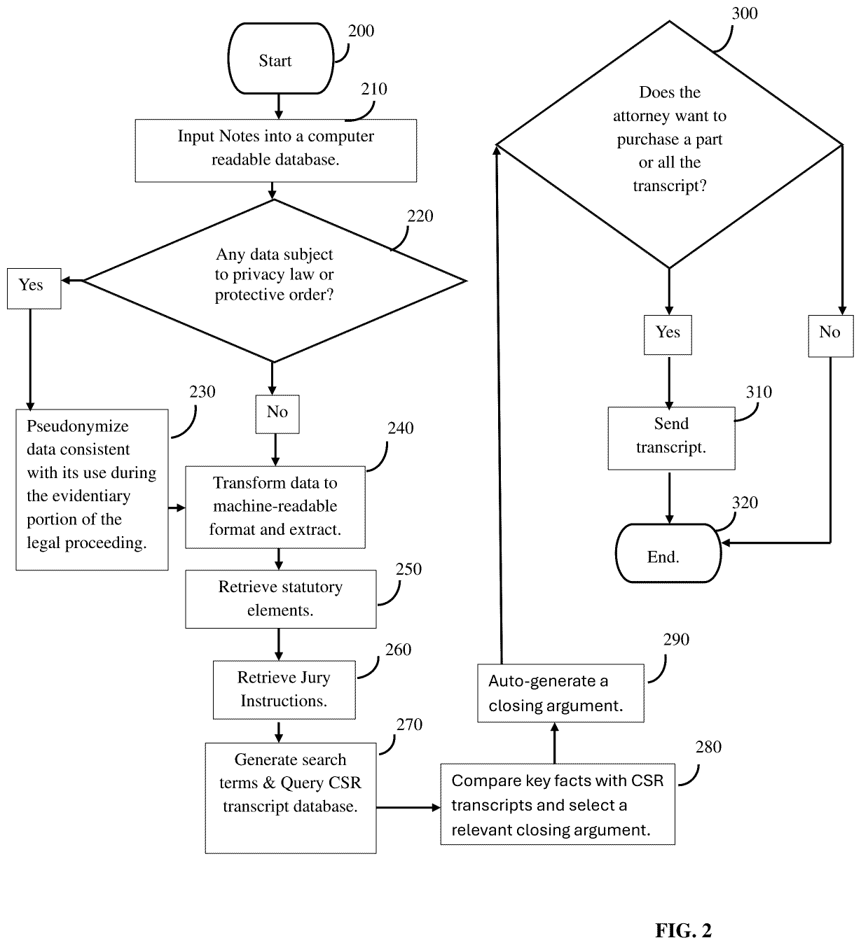

FIG. 2 is a flowchart illustrating, in greater detail, one method of using the Closing Argument Tool (CAT) 160, as shown in FIG. 1, to assist in preparing a closing argument for a pending case, according to one embodiment.

Beginning at step 200, the attorney initiates the process by inputting case-related notes from a pending case into a computer-readable database step 210. The system analyzes the data to determine whether it may contain information subject to privacy laws or protective orders step 220.

If such data is detected, the system proceeds to step 230, where the data is automatically pseudonymized to conform the data to the way the data was presented during the evidentiary portion of the proceeding. Once pseudonymization is complete—or if no protected data is identified—the method advances to step 240, where the case-related notes are converted into a machine-readable format. Structured data is then extracted from the case-related notes, including “key facts” such as attorney observations (e.g., witness uncertainty, poor lighting conditions, etc.), witness admission, exhibit descriptions, etc.

At step 250, the system retrieves the statutory elements corresponding to the alleged offense or cause of action based on jurisdiction-specific legal codes. At step 260, relevant jury instructions may optionally be retrieved using either the statutory elements, information from the charging document. In other embodiments, the jury instructions may be included in the case-related notes. For example, the judge has ruled what jury instructions are going to be read to the jury before the system and method is utilized, so that the user can make the jury instructions part of the case-related notes.

In step 270, the extracted key facts are converted into search parameters to query a structured database of certified shorthand reporter (CSR) transcripts, which have also been transformed into machine-readable format. These transcripts include metadata such as key facts, causes of action, rulings, timestamps, damages sought, parties, and classifications by legal attributes (e.g., federal vs. state case, use of expert witnesses, prosecuting agency, outcomes, and more).

In step 280, the system automatically compares the key facts from the case-related notes with those from the CSR database to identify similar or relevant transcripts. From these, one or more closing arguments are selected based on their relevance to the pending case.

At step 290, the system automatically generates a proposed closing argument tailored to the current case, drawing on arguments used in the selected CSR transcripts. In addition to a portion from an attorney's closing argument taken from the CSR transcripts (e.g., a phrase with a noticeable pattern or cadence, an exclamatory statement, a rhetorical question, a clever argument, a sentence, a story, etc.), the generated argument may include quotes from historical figures, political leaders, entertainers, or athletes to enhance credibility or relatability.

The method may optionally proceed to step 300, where the user is offered the opportunity to purchase the full transcript—or selected pages—for additional context. If declined, the process ends at step 320 and ends. If accepted, the method proceeds to step 310, where the order is processed and the transcript is delivered digitally (e.g., via the attorney's registered email), after which the process concludes at step 320.

The disclosed invention creates a new source of revenue for CSRs and a tool for attorneys. Finally, the invention creates a competitive advantage for attorneys by allowing them to use effective closing arguments of experienced attorneys by selecting only closing arguments from a CSR transcript when an attorney is a “certified expert” who achieved an outcome the user attorney hopes to achieve.

Systems and methods describing the present invention have been described. It will be understood that the descriptions of some embodiments of the present invention do not limit the various alternative, modified, and equivalent embodiments which may be included within the spirit and scope of the present invention as defined by the appended claims. Furthermore, in the detailed description above, numerous specific details are set forth to provide an understanding of various embodiments of the present invention.

However, some embodiments of the present invention may be practiced without these specific details. In other instances, well known methods, procedures, and components have not been described in detail so as not to unnecessarily obscure aspects of the present embodiments.

Lastly, it is intended that the invention encompasses any improved methods, systems, or processes—including those utilizing an agentive AI agent—that are developed in the future for retrieving or transforming information from a certified shorthand reporter (CSR) transcript into a machine-readable format, and for comparing the resulting structured data to key facts from a pending case. Such improvements may include, without limitation, autonomous or semi-autonomous agentive AI systems capable of perceiving, reasoning, and acting upon legal data inputs to achieve the functions described herein. These future-developed solutions, whether performed individually or in combination with other components, are intended to fall within the spirit and scope of the present invention, provided they substantially perform the disclosed functions.

It should be appreciated that the exemplary aspects and features of the present invention as described above are not intended to be interpreted as required or essential elements of the invention, unless explicitly stated as such. It should also be appreciated that the foregoing description of exemplary embodiments was provided by way of illustration only and that many other modifications, features, embodiments and operating environments are possible. Accordingly, the scope of the present invention should be limited only by the claims to follow.

I claim:

1. A system for generating a proposed closing argument for a pending legal proceeding, the system comprising:
a data ingestion module configured to receive legal case-related notes related to a pending legal proceeding;
a transformation engine configured to convert the case-related notes into a machine-readable format and extract structured key facts;
a legal transcript query module configured to use the key facts as search parameters to query a database of machine-readable CSR transcripts comprising historical verbatim closing arguments by attorneys;
a comparison engine configured to identify one or more CSR transcripts containing arguments made involving similar legal or factual circumstances;
a closing argument extraction module configured to select a portion of a prior attorney-delivered argument from the identified CSR transcript and associate it with evidence or argument themes relevant to the pending case; and
a closing argument generation module configured to automatically adapt the portion of the selected historical argument into a proposed closing argument for use in the pending proceeding.

2. The system of claim 1, further comprising a jurisdictional code retrieval module configured to retrieve statutory elements and jury instructions based on the legal jurisdiction of the proceeding.

3. The system of claim 1, further comprising a pseudonymization engine configured to identify and mask personally identifiable information in conformity with the use of that information during the trial.

4. The system of claim 1, wherein one or more of the modules are implemented by vertical artificial intelligence agents trained on, or find-tuned using large language models of legal data including certified court reporter (CSR) transcripts of prior legal proceedings.

5. The system of claim 1, further comprising a style adaptation module implemented by vertical artificial intelligence agents that adjusts the tone, structure, or rhetorical emphasis of the generated argument based on user input or case context.

6. The system of claim 1, further comprising a cue module configured to generate a visual or textual cue indicating when an attorney should reference an exhibit admitted into evidence during delivery of the closing argument.

7. The system of claim 6, wherein the cue corresponds to a slide transition within a presentation application synchronized with the generated closing argument.

8. The system of claim 1, further comprising an interface module configured to provide an option to purchase part or all of the CSR transcript from which a closing argument was selected for additional context and to facilitate monetization of transcripts for court reporters.

9. The system of claim 1, further comprising a vertical AI agent that evaluates exhibit relevance to optimize argument structure and visual presentation integration.

10. A computer-implemented method for assisting in preparation of a closing argument in a legal proceeding, comprising:
receiving case-related notes associated with a pending legal proceeding into a computer-readable database, the case-related notes comprising at least one of a charging document, a trial transcript, legal professional notes, a visual or multimedia depiction of an exhibit, or an observation made in the courtroom that is not part of the official record;
transforming the case-related notes into a machine-readable format and extracting structured data comprising key facts relevant to the proceeding;
retrieving, based on jurisdictional information, applicable statutory elements related to the alleged offense or cause of action;
querying a database of certified court reporter (CSR) transcripts that have been previously transformed into machine-readable format, the transcripts including verbatim attorney arguments recorded during prior trials and classified by metadata including legal, factual, and procedural attributes;
comparing the key facts of the pending proceeding with the metadata and structured content of the CSR transcripts to identify one or more relevant transcripts;
selecting at least a portion of a historical closing argument delivered by an attorney in a prior proceeding, wherein the selected argument is associated with a successful or relevant trial outcome; and
automatically generating a proposed closing argument incorporating the portion of the selected historical closing argument, adapted using the key facts, witness testimony, exhibits, and statutory elements specific to the pending proceeding.

11. The method of claim 10, wherein the automatically generating a proposed closing argument further comprises incorporating a rule from jurisdiction specific jury instructions to generate the proposed closing argument.

12. The method of claim 10, wherein the observation made in the courtroom comprises one of witness demeanor, an observed witness's physical reaction to a question, or witness's response latency to a question while testifying.

13. The method of claim 10, wherein the key facts include information indicating evidentiary inconsistencies, factual support for or against legal elements, or attorney observations.

14. The method of claim 10, wherein the selected historical closing arguments are filtered to match the same or similar crime charged, cause of action, jurisdiction, or fact pattern as the pending trial.

15. The method of claim 10, wherein the proposed closing argument includes suggested rhetorical techniques or persuasive phrases derived from previously successful arguments.

16. The method of claim 10, further comprising the step of enabling the attorney to select a desired rhetorical style or argument format to guide the generation of the proposed closing argument.

17. The method of claim 10, further comprising the step of performing one or more of the method's sub-tasks using vertical artificial intelligence agents trained on large language models, wherein said agents are retrained or updated based on user feedback indicating the effectiveness or usability of the generated closing argument.

18. The method of claim 10, further comprising the step of enabling the attorney to select a desired rhetorical style or argument format to guide the generation of the proposed closing argument.

19. A non-transitory computer-readable medium storing instructions that, when executed by one or more processors, cause a computing device to perform a method for assisting an attorney in preparing for closing argument, the method comprising:
receiving case-related notes data related to a pending legal case;
converting the case-related notes into a machine-readable format;
parsing the machine-readable case-related notes data to extract structured data, wherein the structured data comprises key facts;
using the extracted key facts as search parameters to query a database of court reporter transcripts that have been previously converted into machine-readable format;
parsing the machine-readable CSR transcripts to extract structured data comprising key facts;
comparing the structured key facts of the case-related notes with the structured data of the CSR transcripts to identify one or more transcripts that contain the same or similar key facts relevant to the pending case;
selecting, from the identified CSR transcripts, one or more closing arguments used by an attorney during trial;
associating each selected argument with a party or witness in the pending case;
generating a closing argument adapted to the key facts of the pending case for use by an attorney during closing argument based on the selected CSR transcript closing arguments made by an attorney.

20. The method of claim 19, wherein the generated closing argument incorporates text adapted by a vertical artificial intelligence agent from a previously recorded attorney argument, and the argument is presented in an editable format to enable the agent to be retrained or updated based on user edits and feedback.
